(19) United States
(12) Patent Application Publication
(10) Pub. No.: US 2008/0173460 A1
(43) Pub. Date: Jul. 24, 2008

(54) Air tool with double exhaust pipes

(76) Inventors: Yung-yung Sun, Dali City (TW); Chuan-ching Cheng, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/655,933

(22) Filed: Jan. 22, 2007

(51) Int. Cl. B25F 5/00

(52) U.S. Cl. 173/219; 173/218

(57) ABSTRACT

An air tool with two exhaust pipes has a case that holds an air inlet, an air motor, an inlet switch for controlling the operation of the air motor, and an action element driven by the air motor. Both sides of the air tool are provided with an exhaust pipe connecting to the air motor. During the operation of the air tool, the exhaust is expelled via the two exhaust pipes simultaneously.

### BACKGROUND OF THE INVENTION

1. Field of Invention

The invention relates to an air tool with double exhaust pipes and, in particular, to an air tool that expels exhaust from both sides when in use.

2. Related Art

Generally speaking, an air tool driven by air has to have an air inlet for air to enter and an air outlet for air to leave. When the air tool is in action, the air enters the air tool via the air inlet to power a driving element in the air tool. The used air then becomes exhaust and is expelled into the environment via the air outlet.

A large air tool requires a larger air pressure to drive its air motor than a smaller one. Therefore, the entering airflow has to match the required amount. As a consequence, the size of the air inlet has to be enlarged. Correspondingly, the size of the air outlet needs to be enlarged as well in order to expel the increased entering airflow so that the driving efficiency is not reduced.

When the exhaust increases in the common air tools seen on the market, the high pressure air usually leaves via a single air outlet. This often results in large and high-pitch noises. Even those installed with sound-absorbing foams still have this problem. Therefore, it is important to resolve this problem for air tools with a large exhaust rate.

### SUMMARY OF THE INVENTION

An objective of the invention is to provide an air tool with double exhaust pipes. The exhaust of the air tool can be expelled from both sides at the same time during its operation. Therefore, the large exhaust is divided into two channels to reduce the noises.

The disclosed air tool has a case that holds an air inlet, an air motor, an inlet switch for controlling the operation of the air motor, and an action element driven by the air motor. Each of the two sides of the case has a pipe connecting the air motor and the external environment for the air motor to expel the exhaust. They are symmetric with respect to and perpendicular to a transmission axis of the air motor.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention;

FIG. 2 is a side view of the cross section of the invention;

FIG. 3 is a top view of the cross section of the invention;

FIG. 4 is a schematic view of how the exhaust is expelled according to the invention;

FIG. 5 is a three-dimensional view of a second embodiment of the invention; and

FIG. 6 schematically shows how the exhaust is expelled according to the second embodiment.

### DETAILED DESCRIPTION OF THE INVENTION

The present invention will be apparent from the following detailed description, which proceeds with reference to the accompanying drawings, wherein the same references relate to the same elements.

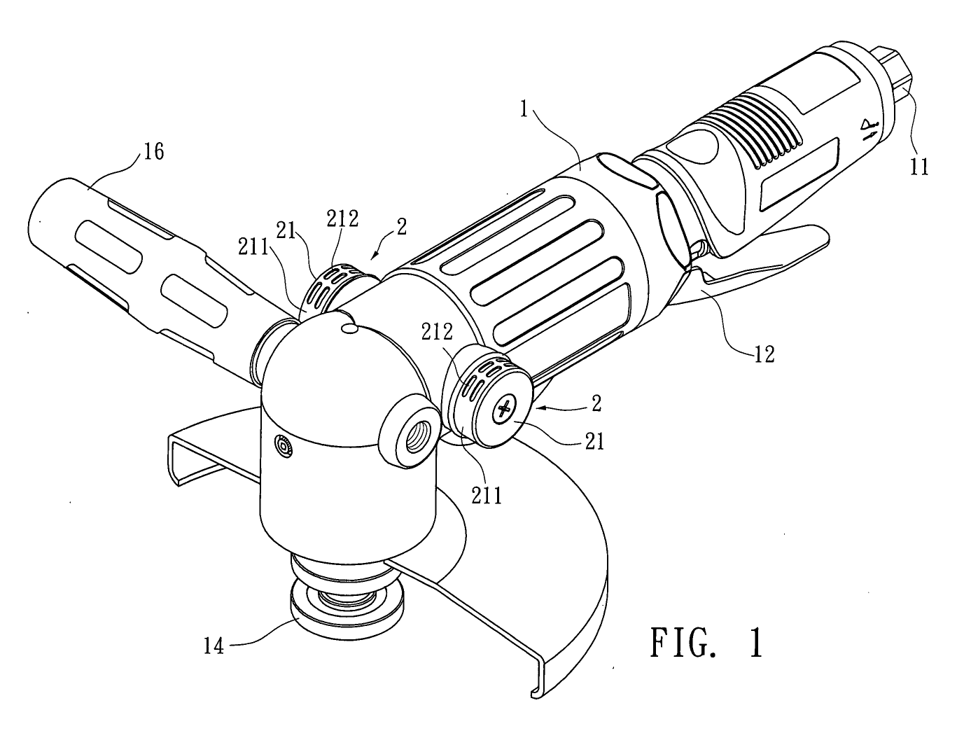

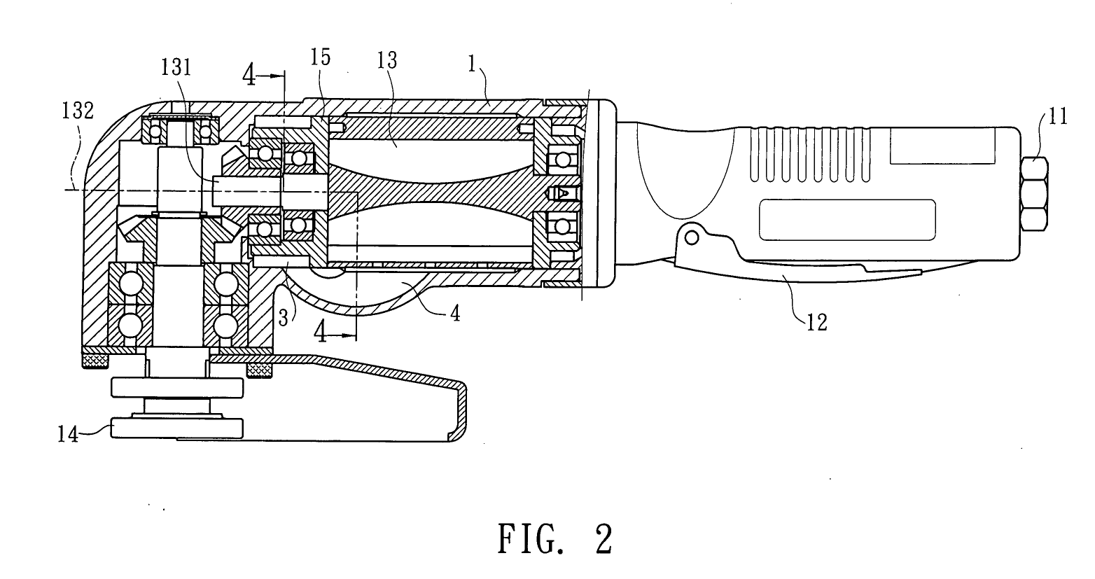

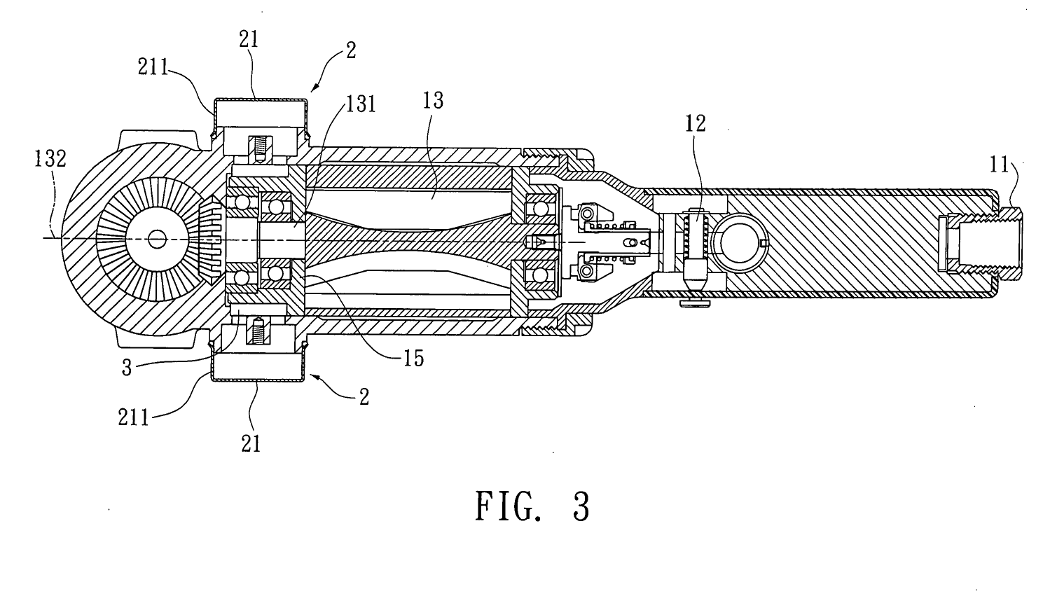

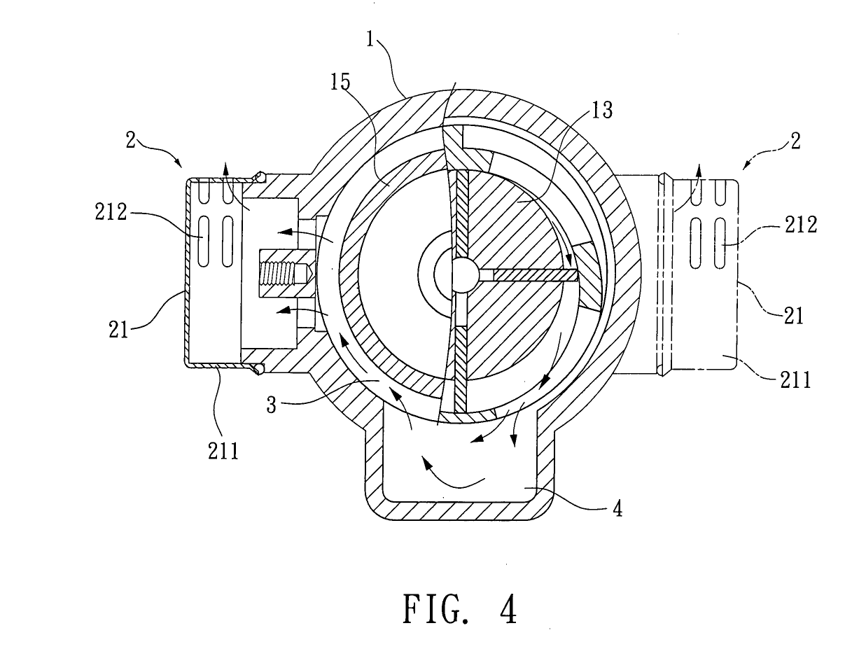

A preferred embodiment of the invention is illustrated in FIGS. 1 to 4. The air tool in this embodiment is a 90-degree air grinder. As shown in the drawing, the air grinder has a case 1. The rear section of the case 1 is provided with an air inlet 11. One side of the case 1 is provided with an inlet switch 12. An air motor 13 is disposed in the middle section of the case 1. The front section of the case 1 has a grinding portion 14 at an angle of 90 degrees with respect to and driven by a shaft 131 of the air motor 13. The high pressure air is controlled by the inlet switch 12 to enter and rotate the air motor 13, which in turn drives the grinding portion 14.

Each side of the case 1 is provided with an exhaust pipe 2 connecting the air motor 13 and the external environment for expelling the exhaust from the air motor 13. In this embodiment, a space 3 connecting to the two exhaust pipes 2 is formed between the case 1 and a shaft base 15 in the vicinity of the grinding portion 14. A channel 4 connecting the air motor 13 and the space 3 is formed inside the case 1 at the bottom of the air motor 13. The two exhaust pipes 2 are disposed around the case 1 in the axial direction. Therefore, the air motor 13 is connected to the space 3 between the case 1 and the shaft base 15 via the channel 4. It is then connected to the external environment via the exhaust pipes 2 on both sides of the case 1.

The exhaust pipe 2 on each side of the air grinder in this embodiment is pivotally disposed with a rotatable cover 21. Each cover 21 has several exhaust holes 212 formed on its surrounding surface 211 to rotate with the cover 21 for changing the exhausting direction. A sound-absorbing foam (not shown in the drawing) for reducing the exhaust noises is further provided inside the exhaust pipe 2. The sound-absorbing foam is positioned by the cover 21 of the corresponding exhaust pipe 2.

A handle 16 that prevents the user's hand from blocking the outgoing exhaust from the exhaust pipe 2 is provided on the case 1, at the end of the grinding portion. It is provided for the user's convenience to hold the case 1. It is in the vicinity of any one of the two exhaust pipes 2 and perpendicular to the transmission axis 132 of the air motor 13.

After the inlet switch 12 for controlling the air motor 13 is depressed, high pressure air enters the air grinder via the air inlet 11 to drive the air motor 13. The air motor 13 in turns drives the grinding portion 14 in the front section of the air grinder. After driving the air motor 13, the air becomes exhaust. It is expelled outside the air grinder via the channel 4 at the bottom of the air motor 13, the space 3 between the shaft base 15 and the case 1, and the exhaust pipes 2 on both sides of the case 1.

A primary advantage of the invention is that when high pressure air leaves the air grinder at a large rate, it is expelled via the two exhaust pipes 2. This can greatly reduce the loud and high-pitch noises.

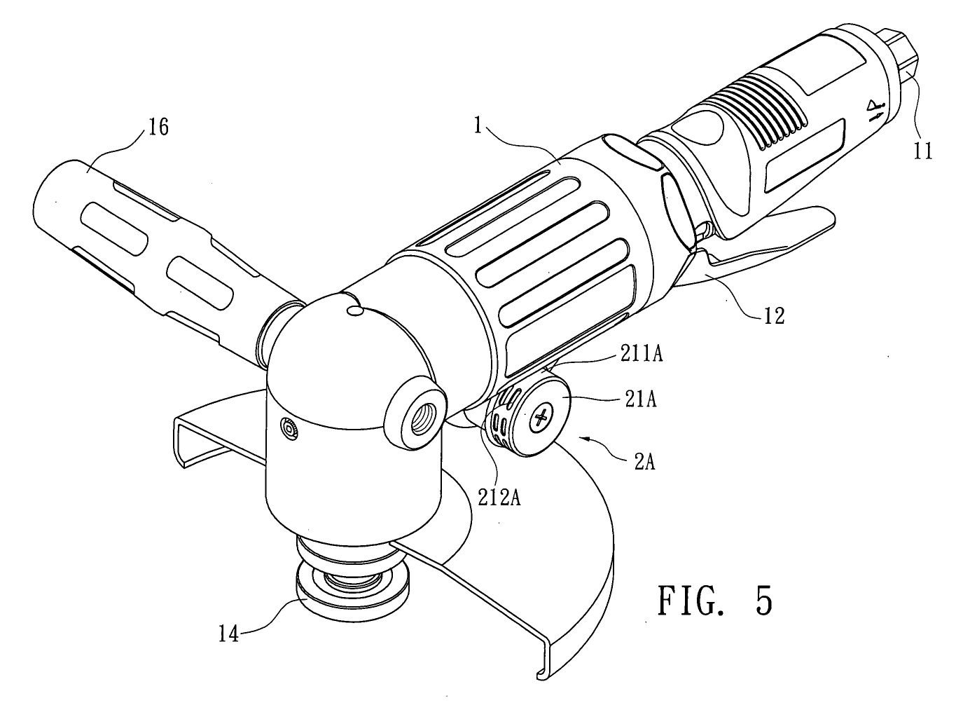

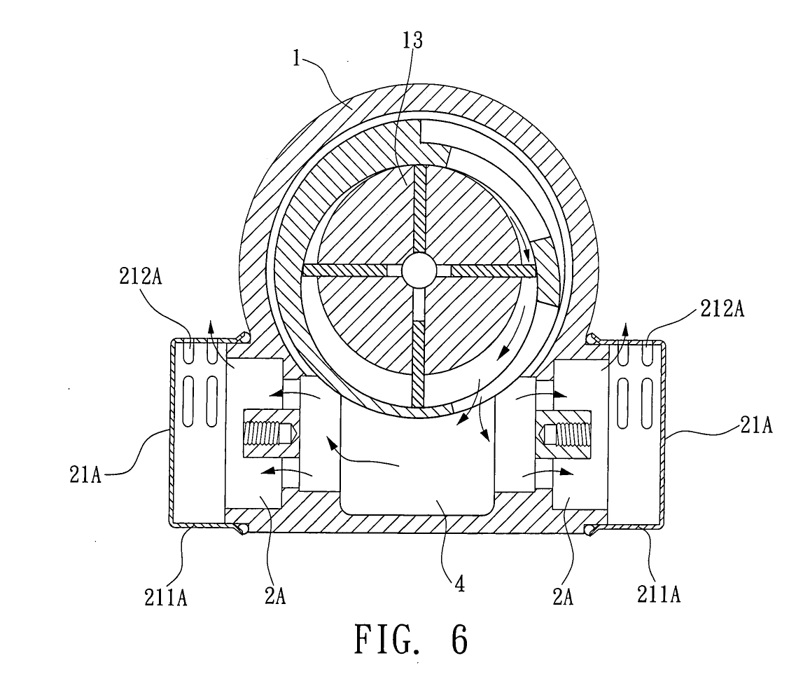

The invention of course has many other variations that are obvious to people skilled in the art. For example, a second embodiment of the invention is shown in FIGS. 5 and 6. The two exhaust pipes 2A are disposed perpendicular to the transmission axis 132. They are also disposed on both sides of the case 1 that encloses the channel 4. This configuration also achieves the same effects as in the first embodiment.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An air tool with two exhaust pipes, which comprises:
a case, which has an air inlet, an air motor, an inlet switch for controlling the operation of the air motor, and an action element driven by the air motor; and
an exhaust pipe on each side of the case to connect the air motor with the external environment for expelling exhaust from the air motor;
wherein the exhaust pipes are symmetric with respect to and perpendicular to a transmission axis of the air motor.

2. The air tool with two exhaust pipes of claim 1, wherein
a space connected with the two exhaust pipes is formed between the case and a shaft base in the vicinity of the action element;
a channel connecting the air motor and the space is formed inside the case at the bottom of the air motor; and
the two exhaust pipes are axially disposed on the case around the shaft base.

3. The air tool with two exhaust pipes of claim 1, wherein
a space connected with the two exhaust pipes is formed between the case and a shaft base in the vicinity of the action element;
a channel connecting the air motor and the space is formed inside the case at the bottom of the air motor; and
the two exhaust pipes are perpendicular to the transmission axis and axially disposed on both sides of the case that encloses the channel.

4. The air tool with two exhaust pipes of claim 2, wherein each of the exhaust pipes is pivotally installed with a rotatable cover that has several exhaust holes formed on its surrounding surface for changing the exhausting direction, and a sound-absorbing foam for reducing the exhaust noises is disposed in each of the exhaust pipes.

5. The air tool with two exhaust pipes of claim 3, wherein each of the exhaust pipes is pivotally installed with a rotatable cover that has several exhaust holes formed on its surrounding surface for changing the exhausting direction, and a sound-absorbing foam for reducing the exhaust noises is disposed in each of the exhaust pipes.

6. The air tool with two exhaust pipes of claim 2, wherein a handle for preventing the user's hand from blocking the exhaust from the exhaust pipes is provided on the case, at the end of the action element in the vicinity of the exhaust pipe and perpendicular to the transmission axis.

7. The air tool with two exhaust pipes of claim 3, wherein a handle for preventing the user's hand from blocking the exhaust from the exhaust pipes is provided on the case, at the end of the action element and perpendicular to the transmission axis.
